(19) United States
(12) Patent Application Publication
(10) Pub. No.: US 2012/0299825 A1
(43) Pub. Date: Nov. 29, 2012

(54) MOBILE DEVICE AND DISPLAY CONTROL METHOD

(75) Inventor: Tomoyasu Takahashi, Yokohama-shi (JP)

(73) Assignee: KYOCERA CORPORATION, Kyoto (JP)

(21) Appl. No.: 13/575,785

(22) PCT Filed: Jan. 27, 2011
(86) PCT No.: PCT/JP2011/051664

§ 371 Date: Jul. 27, 2012

(30) Foreign Application Priority Data
Jan. 27, 2010 (JP) 2010-016075

(51) Int. Cl. G06F 3/038; G06F 3/01

(52) U.S. Cl. 345/156; 345/204

(57) ABSTRACT

According to an aspect, a mobile device includes a housing, a display unit, a storage unit, and a control unit. The housing is configured to be switched to an opened state or a closed state. The display unit displays a standby screen. The display unit is exposed in any state of the opened state and the closed state of the housing. The storage unit stores a first object and a second object to be displayed on the standby screen. The control unit causes the first object to be displayed in a first state where the standby screen is displayed in the closed state, and the second object to be displayed in a second state where the standby screen is displayed in the opened state.

### CROSS-REFERENCE TO RELATED APPLICATION

This application is a National Stage of international application No. PCT/JP2011/051664 filed on Jan. 27, 2011 which designates the United States, and which is based upon and claims the benefit of priority from Japanese Patent Application No. 2010-016075, filed on Jan. 27, 2010.

### FIELD

The present disclosure relates to a mobile device and a display control method for displaying an image on a display unit.

### BACKGROUND

Conventionally, some mobile devices, such as mobile phones, display a standby screen as a screen for standing by an operation. For example, a time or an image selected by a user can be displayed on the standby screen. In addition, as for a device that displays an image on the desktop screen, Patent Literature 1 describes a device that displays an electronic sticky note on the screen.

### CITATION LIST

### Patent Literature

Patent Literature 1: Japanese Patent Application Laid-Open No. 2004-287559

### TECHNICAL PROBLEM

For the display unit of a mobile device, an electronic sticky note is also displayed on a standby screen, so that useful information can be displayed on the display unit. However, when the number of stick-on objects, such as electronic sticky notes and the like, to be displayed increases, it would take a long time to find a necessary electronic sticky note, thus lowering the effectiveness of electronic sticky notes. Furthermore, when the number of electronic sticky notes to be displayed on a standby screen increases, there would be a problem in which an original standby screen cannot be viewed.

For the foregoing reasons, there is a need for a mobile device and a display control method which are capable of displaying more effective information on a display unit.

### SUMMARY

According to an aspect, a mobile device includes: a housing capable of being opened or closed; a display unit for displaying a standby screen for standing by activation of a function that the mobile device has or generation of transmission, the display unit being exposed in any state of an opened state and a closed state of the housing; a storage unit for storing a first object to be displayed on the standby screen and a second object differing from the first object; and a control unit for causing the first object to be displayed in a first state where the standby screen is displayed in the closed state, and the second object to be displayed in a second state where the standby screen is displayed in the opened state.

According to another aspect, the storage unit stores an icon alone, as the first object, and the icon and text information or an explanatory sentence of a shortcut function with which the icon is associated, as the second object.

According to another aspect, the storage unit stores text data as the first object, and data including shortcut data as the second object.

According to another aspect, the control unit does not display the first object in the second state.

According to another aspect, the control unit further displays the first object in the second state.

According to another aspect, the mobile device further includes an operating unit disposed at a location to be hidden by the housing when the housing is in the closed state.

According to another aspect, the mobile device further includes: a first operating unit placed in a location not to be hidden even when the housing is in the closed state, and a second operating unit placed in a location to be hidden in the closed state.

According to another aspect, the first object is associated with a function or information which is executable via the first operating unit and without using the second operating unit, and the second object is associated with a function or information, an execution of which requires an operation of the second operating unit.

According to another aspect, the housing includes a first housing, and a second housing disposed overlapping the first housing, and the closed state and the opened state are switched by relatively moving the first housing and the second housing while respective opposed faces of the first housing and the second housing are maintained in parallel to each other.

According to another aspect, the mobile device further includes g a call key; a direction key; a number key at least placed at a location to be hidden when the housing is in the closed state; and a communication unit. In a state where the standby screen and the second object are displayed on the display unit, when the direction key is operated, the second object is selected, and when the number key is operated, movement to a screen on which a number corresponding to the operated key is displayed on the display unit is made, and then, when the call key is operated, the communication unit performs a calling process by using an input number sequence as a telephone number.

According to another aspect, a mobile device includes: a housing capable of being opened or closed; a display unit for displaying a standby screen for standing by activation of a function that the mobile device has or generation of transmission, the display unit being exposed in any state of an opened state and a closed state of the housing; a storage unit for storing an object associated with an icon and a text and to be displayed on the standby screen; and a control unit for causing the object to be displayed by using the icon that does not accompany the text in a first state where the standby screen is displayed in the closed state, and the object that accompanies the text to be displayed in a second state where the standby screen is displayed in the opened state.

According to another aspect, the housing includes a first housing, and a second housing disposed overlapping the first housing, and the closed state and the opened state are switched by relatively moving the first housing and the second housing while respective opposed faces of the first housing and the second housing are maintained in parallel to each other.

According to another aspect, a display control method is performed in a mobile device including a housing capable of being opened or closed, a display unit being exposed in any of cases where the housing is opened and closed, and a storage unit for storing various pieces of information. The display control method includes: displaying a standby screen on the display unit, the standby screen standing by activation of a function that the mobile device has or generation of communication; and displaying a first object to be displayed on the standby screen in a first state where the standby screen is displayed in a closed state, and a second object differing from the first object in a second state where the standby screen is displayed in an opened state.

According to another aspect, a display control method is performed in a mobile device including a housing capable of being opened or closed, a display unit being exposed in any of cases where the housing is opened and closed, and a storage unit for storing various pieces of information. The display control method includes: displaying a standby screen on the display unit, the standby screen standing by activation of a function that the mobile device has or generation of communication; and displaying the object by using an icon that does not accompany the text in a first state where the standby screen is displayed in a closed state, and the object that accompanies the text in a second state where the standby screen is displayed in an opened state.

### ADVANTAGEOUS EFFECTS OF INVENTION

The mobile device and the display control method according to the present invention have an effect of being able to display easy-to-understand and more effective information on a display unit.

### BRIEF DESCRIPTION OF DRAWINGS

FIG. 1 is a perspective view illustrating a schematic configuration of a mobile device according to an embodiment of the present invention.

FIG. 2 is a perspective view illustrating another state of the mobile device illustrated in FIG. 1.

FIG. 3 is a block diagram depicting a schematic functional structure of the mobile device illustrated in FIG. 1.

FIG. 4 is a flowchart depicting an example of a process operation which the mobile device performs.

FIG. 5 is an explanatory view for explaining an operation of the mobile device.

FIG. 6 is an explanatory view for explaining an operation of the mobile device.

FIG. 7 is an explanatory view for explaining an operation of the mobile device.

FIG. 8 is an explanatory view for explaining an operation of the mobile device.

FIG. 9 is an elevation view illustrating a schematic configuration of a mobile device according to another embodiment.

FIG. 10 is an elevation view illustrating another state of the mobile device illustrated in FIG. 9.

FIG. 11 is a flowchart depicting an example of a process operation which the mobile device performs.

### DESCRIPTION OF EMBODIMENTS

Thereinafter, the present invention will be described in detail, with reference to the drawings. Note that the following explanation is not intended to limit the present invention. In addition, components in the following explanation include ones that easily occur to those skilled in the art, ones substantially identical, and ones falling within the so-called equivalent scope. Thereinafter, a mobile phone that is an example of a mobile device will be explained as an example, but a target to which the present invention is applicable is not limited to mobile phones. A mobile device of the present invention is applicable to, for example, PHSs (personal handy-phone systems), PDAs, portable navigation devices, portable gaming devices, and the like.

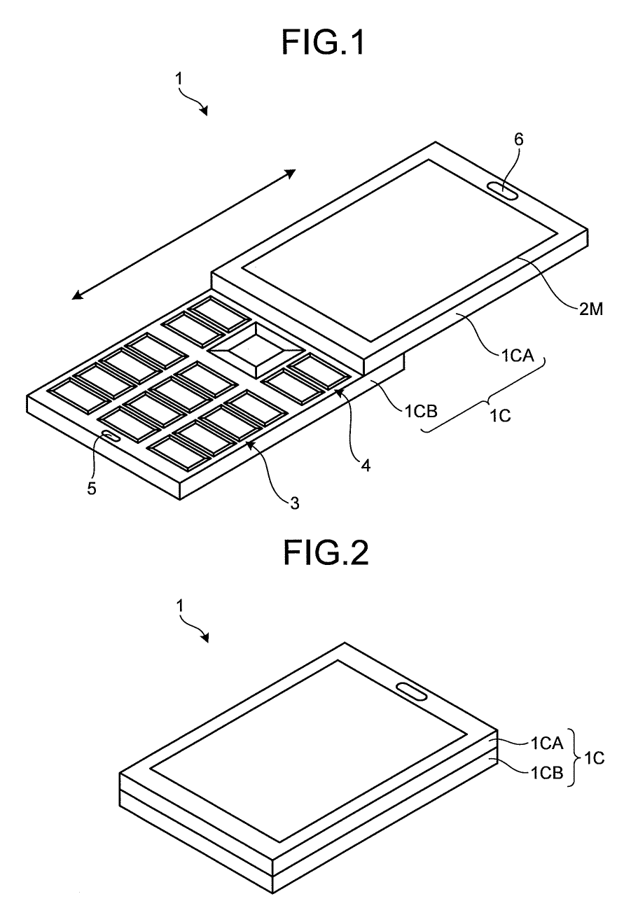

FIG. 1 is a perspective view illustrating a schematic configuration of a mobile device according to an embodiment of the present invention. FIG. 2 is a perspective view illustrating another state of the mobile device illustrated in FIG. 1. A mobile device 1 is a mobile phone equipped with a wireless communication function. The mobile device 1 is a slide type mobile device in which a housing 1C is slidably configured of a first housing 1CA and a second housing 1CB. Note that FIG. 1 illustrates a state where the mobile device 1 is opened (hereinafter, also called “opened state”), whereas FIG. 2 illustrates a state where the housing 1C of the mobile device 1 is closed (hereinafter, also called “closed state”).

The first housing 1CA and the second housing 1CB each have a substantially rectangular shape, and are arranged such that the respective faces thereof having the largest surface area are oriented to face each other. In addition, the first housing 1CA is coupled to the second housing 1CB with a slider mechanism so as to be movable in the longitudinal direction of the respective opposed faces thereof (in a direction of an arrow in FIG. 1) while the opposed faces are substantially parallel to each other (in the facing state). Thus, the first housing 1CA and the second housing 1CB are configured to be relatively movable between positions illustrated in FIGS. 1 and 2.

The first housing 1CA is provided with a main display 2M illustrated in FIG. 1 on the face opposite to that facing the second housing 1CB, as a display unit. The main display 2M displays, as a predetermined image, a standby screen in a state where the mobile device 1 stands by reception, or a menu image to be used for assisting the operations of the mobile device 1. Since being provided on the face opposite to that facing the second housing 1CB, the main display 2M is always in an exposed state, independently of the form of the housing 1C. As illustrated in FIG. 1, the first housing 1CA is provided with a receiver 6 that outputs voice during a telephone conversation in the mobile device 1.

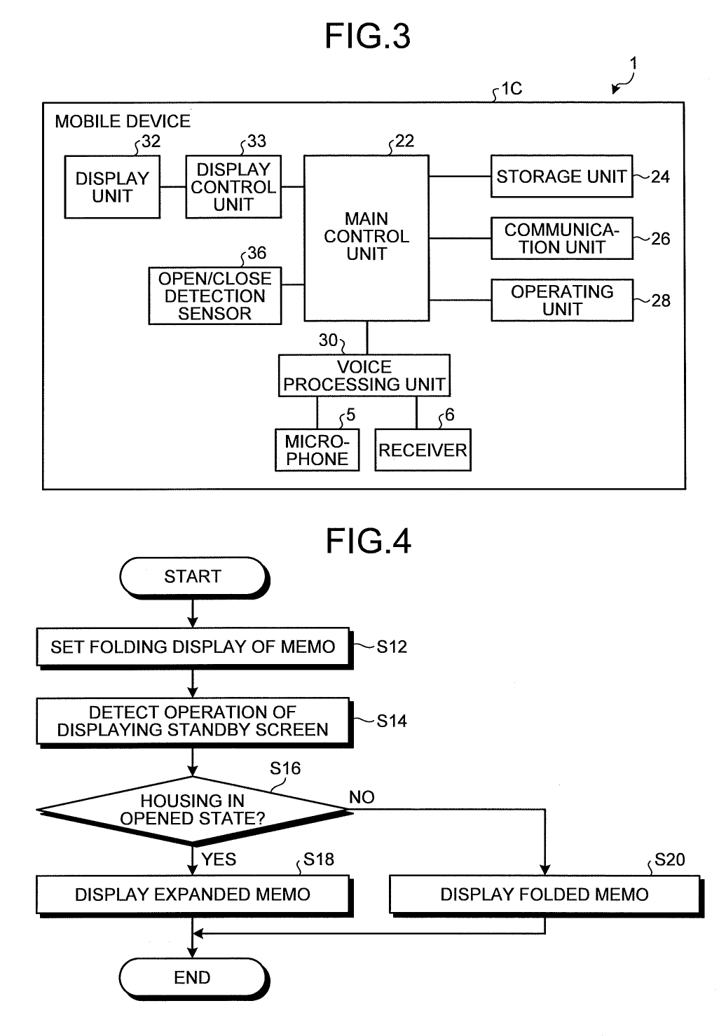

The face of the second housing 1CB which faces the first housing 1CA is provided with a plurality of operation keys 3 for inputting telephone numbers for intended parties or letters upon composing e-mails and the like, as well as direction/decision keys 4 for facilitating the selection and decision of a menu displayed on the main display 2M, scrolling of the screen, submission, ringing-off, and the like. The operation keys 3 and the direction/decision keys 4 constitute an operating unit 28 (see FIG. 3) in the mobile device 1. Since being provided on the face facing the first housing 1CA, the operation keys 3 and the direction/decision keys 4 are in a state of being hidden by the first housing 1CA when the housing 1C is in a closed state, namely, the housing 1C has the form illustrated in FIG. 2. Meanwhile, the operation keys 3 and the direction/decision keys 4 are in a state of being exposed when the housing 1C is in the opened state, as illustrated in FIG. 1. In addition, the second housing 1CB is provided with a microphone 5 that receives voice during a telephone conversation in the mobile device 1.

Next, an explanation will be given of a relationship between the function of the mobile device 1 and a control unit thereof. FIG. 3 is a block diagram depicting a schematic functional structure of the mobile device illustrated in FIG. 1. As illustrated in FIG. 3, the mobile device 1 includes a main control unit 22, a storage unit 24, a communication unit 26, the operating unit 28, a voice processing unit 30, a display unit 32, a display control unit 33, and an open/close detection sensor 36.

The main control unit 22 is a control unit, such as a CPU (central processing unit), that integrally controls an overall operation of the mobile device 1. Specifically, operations of the communication unit 26, the display unit 32, and the like, are controlled in such a way that the mobile device 1 performs various processes in proper order in accordance with operations via the operating unit 28 or software stored in the storage unit 24 of the mobile device 1. The main control unit 22 performs processing on the basis of program (for example, operating system program, application program, and the like) stored in the storage unit 24. In addition, the main control unit 22 executes an application that controls the display of an image to be displayed in a standby state, namely, the display of a standby screen. In this case, the standby screen refers to a screen that is to be displayed when a process of starting up the mobile device 1 has been completed and when the activation of another application is being waited for after one active application is terminated. Specifically, the standby screen refers to a screen in a state where an incoming or outgoing telephone call is stood by, or in a state where activation of an application program is stood by. In other words, the standby screen refers to a previous screen that is to be changed into each of various functional screens provided by the mobile device 1. The standby screen is also referred to as, for example, a desktop screen, a home screen, or a wallpaper. The standby screen is not limited to a plain screen, and image data or animation data can be displayed as the standby screen. Part of the standby screen may include a portion that is dynamically changed, like a calendar or a clock. The user sets a favorite image or a status display of a clock or the like as the standby screen in advance.

The storage unit 24 stores application program and/or data to be used for processing performed by the main control unit 22. Specifically, as the application program, ones for controlling the display of the standby screen, communicating through the Internet, sending or receiving e-mails, performing submission, reception and telephone conversations, and the like are stored. As the data, image data, audio data, dictionary data for converting characters, address book data, and the like are stored. Moreover, the storage unit 24 stores information regarding images to be displayed on the standby screen, and stick-on objects. The stick-on objects will be explained hereinafter. The storage unit 24 is configured to connect to an external storage device to/from which data can be stored/read, and to store data in the external storage device under the control of the main control unit 22. The main control unit 22 can also read out data stored in the external storage device, and send the readout data to the main control unit 22.

The communication unit 26 establishes a wireless signal path based on the CDMA system and the like for a base station through a channel allocated by the base station, and conducts telephone and information communications with the base station. Also, the communication unit 26 is equipped with antennas for receiving TV broadcasts and GPS signals.

The operating unit 28 includes the operation keys 3 to which various functions, such as power, conversation, number, letter, direction, decision, call (submission) keys and the like, are allocated, and the direction/decision keys 4. When these keys are input through an operation of a user, the operating unit 28 generates a signal corresponding to this operation. Then, the generated signal is input to the main control unit 22 as an instruction from the user.

The voice processing unit 30 performs the processing of sound signals to be input to the microphone 5 and to be output from the receiver 6.

The display unit 32 is provided with a display panel (the above main display 2M, etc.) composed of an LCD (liquid crystal display), an organic EL (organic electro-luminescence) panel, or the like, and displays, on the display panel, video according to video data supplied from the main control unit 22 through the display control unit 33, or an image according to the image data supplied therefrom.

The open/close detection sensor 36 determines whether the housing 1C is in the opened state or in the closed state. Specifically, the open/close detection sensor 36 determines that a state where the face of the second housing 1CB on which the operation keys 3 and the direction/decision keys 4 are arranged is exposed (namely, the state illustrated in FIG. 1) is the opened state. Meanwhile, the open/close detection sensor 36 determines that a state where respective faces of the first housing 1CA and the second housing 1CB which face each other fully overlap each other (namely, the state illustrated in FIG. 2) is the closed state. Note that any of various sensors which detect the form of the housing 1C can be used as the open/close detection sensor 36. For example, a sensor that can at least detect whether or not the form of the housing 1C is in the closed state can be used. The open/close detection sensor 36 at least detects whether or not it is the closed state, and any cases where the open/close detection sensor 36 cannot detect the closed state may be regarded as the opened state. Thus, it is made possible to determine whether the housing 1C is in the opened state or in the closed state.

Next, an explanation will be given of an operation of the mobile device 1, specifically an image display processing of the display unit 32 which is performed by the main control unit 22. FIG. 4 is a flowchart depicting an example of a process operation which the mobile device performs. In this case, the main control unit 22 in the mobile device 1 according to the embodiment displays, on a standby screen, a stick-on object that has been set by a user. Examples of the stick-on object include an object composed of text (letter information), an object related to a shortcut function, and the like. The object can be associated with an icon selected from a plurality of icons. Note that these objects can be displayed through the input of a user. The shortcut function refers to a function of jumping over hierarchies and folders upon selection and moving to processing of a specific target (for example, a deep hierarchy on a menu, a URL (uniform resource locator), an image, information regarding a specific person in an address book, or the like). When a user selects an object associated with the shortcut function, it is possible to reach an associated specific target without inputting an operation necessary for moving through hierarchies and folders which is necessary to reach the specific target.

First, the main control unit 22 in the mobile device 1 sets folding display of a memo (text) at Step S12. Specifically, an object to be displayed on a standby screen is set such that only an icon is displayed in the closed state, and an icon and letter information are displayed in the opened state. This setting is performed on the basis of an operation to be input by a user.

After setting the display at Step S12, the main control unit 22 detects an operation of displaying a standby screen and the like at Step S14. When detecting an operation of displaying a standby screen and the like, the main control unit 22 displays the standby screen. In addition, upon displaying the standby screen, the main control unit 22 determines whether or not the housing is in the opened state at Step S16. An operation of displaying a standby screen refers to an operation that is set so as to display a standby screen in response to detection thereof, and is assigned to an operation of opening the housing 1C. The main control unit 22 determines whether or not the housing 1C is in the opened state, on the basis of the detection result of the open/close detection sensor 36.

When determining that the housing 1C is in the opened state (Yes), namely, that the operation keys 3 and the direction/decision keys 4 is in the exposed state at Step S16, the main control unit 22 displays a memo in an expanded manner, and terminates the processing, at Step S18.

In the state where a plurality of objects are displayed on the standby screen, when detecting an upward/downward operation via the direction key, the main control unit 22 performs an operation of selecting an object in accordance with this operation. Thus, the main control unit 22 performs a process of switching objects to be selected (a process of moving a selection cursor), on the basis of the upward/downward operation. In addition, when a decision operation is input in the state where an object has been selected, the main control unit 22 displays detailed information regarding the object or executes an associated function. For example, when a shortcut function is associated, a process of moving to a specific target is performed.

In a case where the decided object is a shortcut function with which a function of a deep hierarchy in a menu is associated as a specific target, when the object is decided, the main control unit 22 displays a screen of the deep hierarchy in the menu. In a case where the decided object is a shortcut function with which contact information in an address book is associated as a specific target, when this object is decided, the main control unit 22 displays the detail of the contact information. In a case where the decided object is a shortcut function with which a favorite or URL of a browser is associated as a specific target, when this object is decided, the main control unit 22 activates the browser, accesses to the Web page of the associated URL and acquires information on the page, or acquires information on the page from a cache, thus displaying a Web page on the screen. Note that when the object is associated with a shortcut function, an explanatory description that describes a function name, a name of a corresponding Web page, or the like may be set as a text of the object, in addition to the icon indicating the function. In a case where the decided object is text data (merely letter information only), when the object is decided, the main control unit 22 displays entire descriptions of the text data. Note that as for a manner of displaying the object, only a constant number of letters (for example, 20 letters) from the head in the text data is displayed prior to the selection and the decision.

Meanwhile, in the state where a stick-on object is displayed on the display unit 32, when a number key, not the direction key, is operated, the main control unit 22 clears the display of the object and displays a number corresponding to the operated number key on the display 32. Thus, the main control unit 22 makes the transition from the screen on which the object is displayed to a screen on which an input numeric value (number) is displayed. Thereafter, when a call key (submission key) is operated after the number keys are operated and the numeric values are input, the main control unit 22 performs a calling process of making a call by using the input numeric value sequence (number sequence) as a telephone number.

When determining that the housing 1C is not in the opened state (Yes), in other words, that the housing 1C is in the closed state, namely, that the operation keys 3 and the direction/decision keys 4 is covered by the he first housing 1CA, the main control unit 22 displays a memo in a folded manner, and terminates the processing.

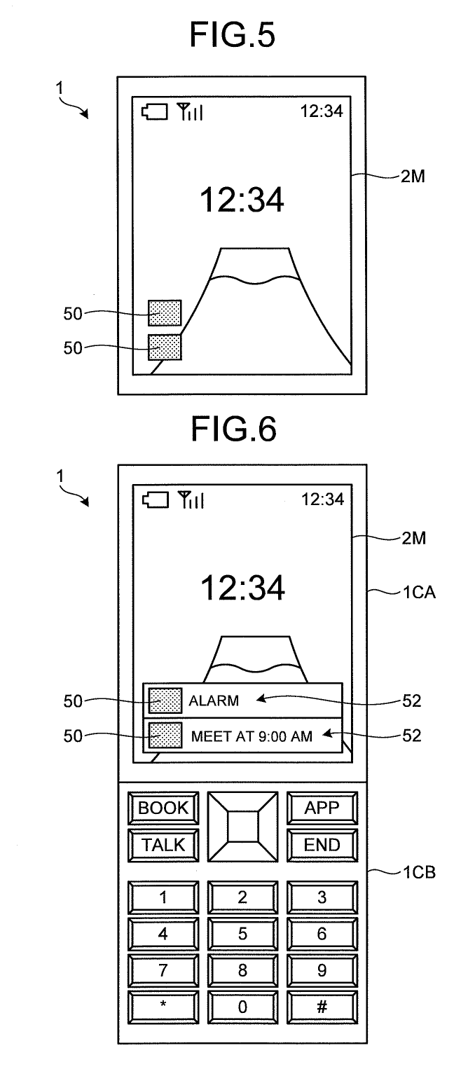

Thereinafter, Steps S18 and S20 will be explained using FIGS. 5 and 6. FIGS. 5 and 6 are explanatory views for explaining respective operations of the mobile device. Specifically, FIG. 5 is an example of a standby screen displayed on the mobile device 1 in the closed state, whereas FIG. 6 is an example of a standby screen displayed on the mobile device 1 in the opened state.

When displaying a text (a memo or an explanatory description) in a folded manner at Step S20, the main control unit 22 displays only icons 50 of objects on the main display 2M, as illustrated in FIG. 5. An image having been set as a standby screen is also displayed on the main display 2M. Accordingly, an image in which objects are superimposed on a standby image is displayed on the main display 2M.

When displaying a memo in an expanded manner at Step S18, the main control unit 22 displays letter information (text information) of the objects on the main display 2M, in addition to the icons 50, as illustrated in FIG. 6.

As described above, the mobile device 1 switches objects to be displayed on a standby screen, in accordance with the form of the housing 1C. Specifically, when the housing 1C is in the closed state, only the icons 50 regarding the objects are displayed. Meanwhile, when the housing 1C is in the opened state, the icons 50 and pieces of letter information 52 regarding the objects are displayed. Switching styles of displaying the objects in accordance with the form of the housing 1C in this manner allows information necessary for an operator to be displayed. Specifically, when wishing to confirm a detail of an image aside from an object, such as a standby image, information regarding a time or the like, a user causes a standby screen to be displayed in the closed state, whereas when wishing to confirm a detail of an object, a user causes the standby screen to be displayed in the opened state. Thus, necessary information can be viewed, simply by switching between the open and the close.

By displaying part of an object (the icon 50 in this embodiment) even in the closed state, it is possible to recognize the presence of the object. In addition, displaying an icon enables the type of an object to be supposed. Furthermore, displaying an icon makes it possible to determine at which location and what type of an object is registered, thereby simplifying the search for a necessary object.

By not displaying at least part of letter information regarding an object in the closed state, a standby screen, which is to be a background image, can be made easy to view. This can improve the visibility of a standby screen that has been set such that a user's favorite image, a time or the like are displayed thereon.

Since neither of the selection of an object via a direction key and a specific action via a decision key, a number key and the like can be done in the closed state, a specific content of a memo is not displayed and a state of implying “there is any object” remains. When a detail of an object (a detail of a memo or a classification of a shortcut function) is necessary, it is possible to grasp the detail thereof, merely by opening the housing. Thus, it is possible to avoid display interference with the display of a state, such as a favorite image designated by a user, a time or the like in the closed state, as well as to provide usability of being able to view a content of the object instantly, simply through an intuitive operation of opening the housing when a user wants a detail of an object.

It may be configured such that an icon can be selected from various types of icons. For example, by allowing an icon corresponding to a detail of a text to be selectable, a detail of the object can be supposed from only the display of the icon. This makes it possible to analogize an object, just like a mark of a knife and a fork (an image of an icon) corresponds to an object regarding a meal, a mark of a child corresponds to a promise to one's child or an event therefor, or a mark of a telephone corresponds to an object regarding an errand for making a call. Even displaying only an icon can fulfill a tickler file function more adequately. Moreover, an icon indicating an application associated with a shortcut function may be able to be selected as an icon.

In any embodiment, about twenty letters of text data of an object from the head is displayed on the standby screen, as letter information of the object. When text data exceeds the number of letters that is allowed to be displayed as letter information, the text data is displayed after an object is selected and decided and a mode of displaying detailed information is established. Note that part of text data (namely, about thirty letters from the head) may be added and displayed in a state an object is selected but not decided.

In the above embodiment, an operation of displaying a standby screen is made an operation of sliding the housing 1C, but the present invention is not limited thereto. Any of various operations can be set to an operation of displaying a standby screen, namely, a trigger operation of displaying an image. For example, pressing a power button, or pressing a predetermined key among operation keys 3 and the direction/decision keys 4 and the like is exemplified.

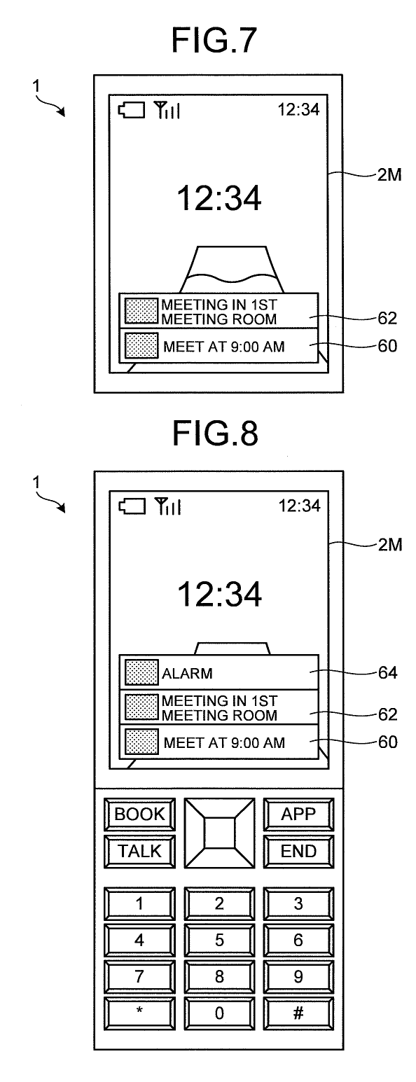

In the above embodiment, an icon of an object is made a first object, whereas an icon of an object and letter information thereof are made a second object. In addition, the first object is displayed in the closed state, whereas the second object is displayed in the opened state. However, the present invention is not limited thereto. For example, the first object may be an object only with letter information, whereas the second object may be an object only with letter information or an object also containing shortcut information. Thereinafter, an explanation will be given using FIGS. 7 and 8. In this case, FIGS. 7 and 8 are explanatory views for explaining respective operations of the mobile device. In the examples illustrated FIGS. 7 and 8, the first object and the second object are set, on the basis of the types of information registered in the objects.

The mobile device 1 performs the common processing until Step S16 of FIG. 4, aside from the process at Step S12. When the housing 1C is in the closed state (namely, at Step S20 upon determination of No at Step S16), the mobile device 1 displays, on the main display 2M, only objects associated with letter information (text data) among objects, as illustrated in FIG. 7. Specifically, two objects, namely, an object 60 to which “meet at 9:00 AM” has been input, and an object 62 to which “meeting in 1st meeting room” has been input are displayed on the main display 2M.

When the housing 1C is in the opened state (namely, at Step S18 upon determination of Yes at Step S16), the mobile device 1 displays, on the main display 2M, images of objects associated with letter information (text data) and an object associated with a shortcut among objects, as illustrated in FIG. 8. Specifically, an object 64 which is provided with a function of a shortcut to an alarm application is displayed on the main display 2M, in addition to the two objects 60 and 62 displayed in FIG. 7.

In this way, the mobile device 1 illustrated in FIGS. 7 and 8 sets the object 64 among objects which is associated with a shortcut as a second object, and displays the object 64 only when the housing 1C is in the opened state. This enables an object that fulfills a function in response to the input through an operation of the operating unit not to be displayed in the state where the operating unit is not exposed. In addition, it is possible to display only a highly effective object in accordance with the form of the housing, thus facilitating the selection of a necessary object. In the closed state, an object of a shortcut which cannot be used anyway is not displayed, thereby being able to attract attention to a memo easily and make a function of a tickler file more prominent.

Note that in the above embodiments, an object made by further adding a predetermined object to the first object is set to the second object, but the present invention is not limited thereto. Specifically, the second object is set so as not to contain the first object. For example, the first object may be set to an object that does not contain shortcut information, whereas the second object may be set to an object that contains shortcut information.

In the above embodiments, rather, only the first object may be displayed when the housing 1C is in the closed state, whereas both the first and second objects may be displayed when the housing 1C is in the opened state, as necessary. Switching between the displays of the first and second objects in this manner also makes it possible to display a highly effective object.

Various ways can be used as a way of classifying objects into the first and second objects. For example, a user may classify individual objects through an operation of the operating unit 28, instead of Step S12. Alternatively, a user may set a classification condition, and the main control unit 22 may classify objects into the first and second objects, on the basis of the set condition. Alternatively, as illustrated in FIG. 5, display ways may be switched even when the same object is displayed. In this case, information regarding a display way is input as first and second objects.

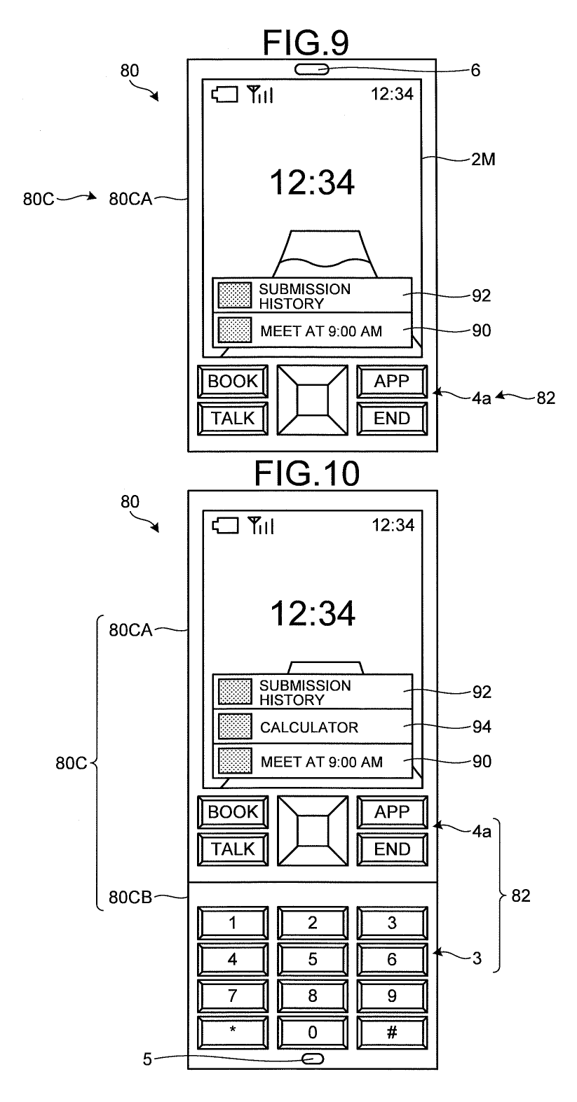

In the above embodiments, the operating unit 28 is configured to be exposed when the housing 1C of the mobile device 1 is in the opened state. In other words, the operating unit is configured to be hidden by the housing 1C when the housing 1C is in the closed state. The present invention is not limited thereto. For example, part of the operating unit may be configured to be exposed even when the housing is in the closed state. Thereinafter, an explanation will be given using FIGS. 9 and 10. FIG. 9 is an elevation view illustrating a schematic configuration of a mobile device according to another embodiment, and FIG. 10 is an elevation view illustrating another state of the mobile device illustrated in FIG. 9.

A mobile device 80 illustrated in FIGS. 9 and 10 has a structure similar to that of the mobile device 1 illustrated in FIGS. 1 and 2 aside from a location where the operating unit is disposed. Accordingly, components of the mobile device 80 which are similar to those of the mobile device 1 are given similar symbols, and an explanation therefor will be omitted. An explanation will be mainly given below of feature points of the mobile device 80. As illustrated in FIGS. 9 and 10, the mobile device 80 is a slide type mobile device in which a housing 80C is also composed of a first housing 80CA and a second housing 80CB.

The face of the first housing 80CA which is opposite to the face facing the second housing 80CB is provided with the main display 2M, as a display unit, illustrated in FIG. 1, a first key group such as direction/decision keys 4a and the like, and the receiver 6. Meanwhile, the face of the second housing 80CB which faces the first housing 80CA is provided with a second key group such as the operation keys 3 including number keys and the like, and the microphone 5. An operating unit 82 of the mobile device 80 includes operation keys 3 and direction/decision keys 4a. The first key group also includes a software key, a mail key, a call key, and the like.

As described above, in the mobile device 80, the first key group is disposed on the face of the first housing 80CA that is always exposed, and the first key group is exposed even when the housing 80C is in the closed state. Meanwhile, the second key group is exposed in the opened state, and hidden in the closed state.

In this mobile device 80, an object associated with an application that is operable via the first key group is set as a first object to be displayed in the closed state. Examples of the object associated with an application that is operable via the first key group also include an object associated with only letter information, namely, an object associated with letter information as an object but no shortcut information. In the mobile device 80, in addition to the first object, an object associated with an application that cannot be operated only via the first key group but requires an operation of the second key group, namely, all objects are set as second objects to be displayed in the opened state.

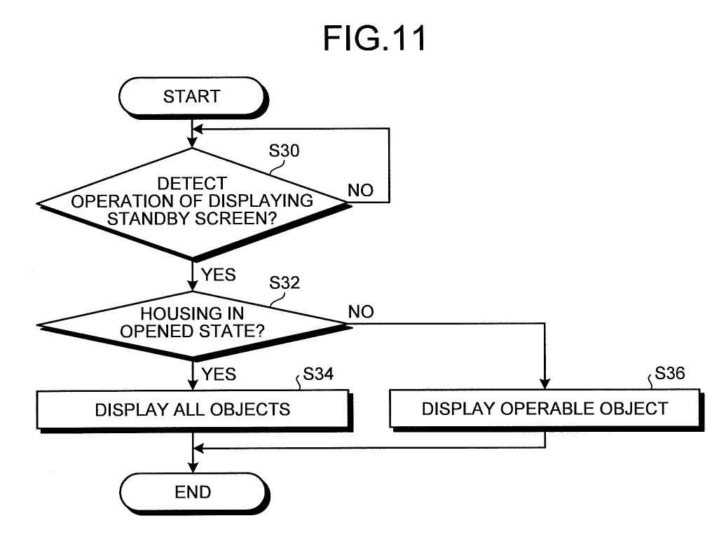

Thereinafter, an operation of the mobile device 80 will be explained using FIGS. 9, 10, and 11. FIG. 11 is a flowchart depicting an example of a process operation which the mobile device performs. First, display setting of objects has been input to the mobile device 80 in advance. Specifically, conditions of classifying and displaying the first and second objects have been input. This state is that where a standby screen is not displayed.

The mobile device 80 (the main control unit thereof) in this state determines whether to detect an instruction or display setting of a standby screen, such as an operation of displaying a standby screen and the like, at Step S30. Examples of the operation of displaying a standby screen includes an operation of opening the housing 80C, pressing of a ringing-off key in the first key group, pressing of a decision key in the first key group, and the like. When determining that the operation of displaying a standby screen has not been detected at Step S30 (No), the mobile device 80 proceeds to Step S30. Specifically, the mobile device 80 repeats the processes of Step S30 until detecting an input of the operation of displaying a standby screen.

Subsequently, when determining that the display operation has been detected (Yes) at Step S30, the mobile device 80 determines whether the housing 80C is in the opened state or not at Step S32. In other words, the mobile device 80 determines whether the housing 80C is in the opened state or in the closed state, with the open/close detection sensor. When determining that the housing 80C has been in the opened state (Yes) at Step S32, the mobile device 80 displays all objects at Step S34. Specifically, the objects that have been set as the second objects are displayed on the main display 2M of the display unit. Thereafter, the mobile device 80 terminates the processing.

In the state where all the objects, namely, the plurality of objects are displayed on the standby screen, when detecting an operation of an upward/downward direction in the direction key, the main control unit 22 performs an operation of selecting an object in accordance with this operation. Furthermore, when an operation of selecting one object from the plurality of objects and deciding the object is input, the main control unit 22 performs the above various processes in accordance with the type of the object.

When determining that the housing 80C is not in the opened state, namely, is in the closed state (No) at Step S32, the mobile device 80 displays an operable object at Step S36. Specifically, an object which has been set as the first object and which is operable via the direction/decision keys 4a exposed even when the housing 80C is in the closed state is displayed on the main display 2M of the display unit. Thereafter, the mobile device 80 terminates the processing.

Consequently, the mobile device 80 displays an object that is operable via the direction/decision keys 4a when the housing 80C is in the closed state, as illustrated in FIG. 9. Specifically, two objects, namely, an object 90 to which “meet at 9:00 AM” has been input, and an object 92 to which “submission history” has been input and which is associated with shortcut information that is to be converted to a screen displaying call history are displayed on the main display 2M. It is possible to scroll a screen on the screen displaying the call history by using the upward/downward direction key of the first key group, and to call to a destination selected via the submission key of the first key group. Thus, the object can be operated by the first key group.

When the housing 80C is in the opened state, the mobile device 80 displays all objects on the main display 2M, as illustrated in FIG. 10. Specifically, an object 94 provided with a shortcut function to a calculator application is displayed on the main display 2M, in addition to the two objects 90 and 92 illustrated in FIG. 9. The calculator application is an application enabling calculation when numeric values are input by pressing the second key group to which numbers have been assigned.

Likewise, in this way, the mobile device 80 in which part of the operating unit is always exposed displays only an operable object on the basis of the opened or closed state of the housing 80C, thereby being able to select and display a more effective object. Thus, it is possible to extract and display an appropriate object in accordance with the state of the mobile device 80 by not displaying an actually non-operable object. This enables the operability to be enhanced.

In the above embodiments, the display and non-display of an object are switched on the basis of the opened or closed state, but the present invention is not limited thereto. For example, the colors of the display may be switched. For example, when an object associated with an application that is operable only via the operation keys is displayed as the first object, the object may be displayed so as to be darker than other objects. Consequently, attention can be attracted to only a usable object, so that a user can find out a target object efficiently.

In the above embodiments, the displays of objects are switched in accordance with the opened or closed state. Further, objects to be displayed may be switched on the basis of a display operation on an input standby screen and the like. For example, an object to be displayed may be displayed by using different objects and/or by employing different display methods even in the same closed state, depending on the cases where the direction/decision key is pressed and where the housing is slid, as the display operation of the standby screen.

In the above embodiments, the mobile device 80 is configured such that the direction/decision keys 4a are always exposed, but a continuously exposed operating unit is not limited thereto. For example, a side key provided on a side face of the housing may be set to a continuously exposed operating unit. In this case, basically, there are no applications that are operable via the side key, though. Substantially, this ends up performing control similar to that in the mobile device 1. In this case, note that since holding down the side key can be set to the operation of displaying the standby screen, it is possible to display the standby screen without sliding the housing while the closed state is maintained.

In the above embodiments, the housing of the mobile device employs a slide type, but the present invention is not limited thereto. The housing may be simply provided with a display unit that is in the exposed state regardless of the opened or closed state. For example, the present invention is also applicable to a so-called turn type mobile device in which two housings are rotatable about an axis orthogonal to respective opposed faces of the housings. The present invention is also applicable to a so-called bi-axis rotatable hinge type mobile device, which has a folded shape and further in which one of housings where a display unit is set is rotatable about the longitudinal direction of the display unit used as a rotation axis. The bi-axis rotatable hinge type mobile device can switch whether or not the display unit faces the other housing, by turning the display unit around the longitudinal direction of the display unit used as a rotation axis. This makes it possible to allow the display unit to be in the exposed state (a state of not being hidden by the housing) even in the closed state.

The present invention is not limited to the above embodiments. For example, the above embodiments may be combined. As an example, operable objects may be displayed in a folded manner (only icons are displayed) when the housing is in the closed state, whereas all objects may be displayed in an expanded manner (namely, icons and pieces of information are displayed) when the housing is in the opened state.

### INDUSTRIAL APPLICABILITY

As described above, the mobile device and the display control method according to the present invention are useful when being applied to a mobile device in which the display unit is in an exposed state even when the housing is in the closed state.

1. A mobile device comprising:
a housing configured to be switched to an opened state or a closed;
a display unit for displaying a standby screen, the display unit being exposed in any state of the opened state and the closed state of the housing;
a storage unit for storing a first object to be displayed on the standby screen and a second object to be displayed on the standby screen; and
a control unit for causing the first object to be displayed in a first state where the standby screen is displayed in the closed state, and the second object to be displayed in a second state where the standby screen is displayed in the opened state.

2. The mobile device according to claim 1, wherein
the storage unit stores an icon alone, as the first object, and the icon and text information or an explanatory sentence of a shortcut function with which the icon is associated, as the second object.

3. The mobile device according to claim 1, wherein
the storage unit stores text data as the first object, and data including shortcut data as the second object.

4. The mobile device according to claim 1, wherein
the control unit does not display the first object in the second state.

5. The mobile device according to claim 1, wherein
the control unit further displays the first object in the second state.

6. The mobile device according to claim 1, further comprising an operating unit disposed at a location to be hidden by the housing when the housing is in the closed state.

7. The mobile device according to claim 1, further comprising:
a first operating unit placed in a location not to be hidden even when the housing is in the closed state; and
a second operating unit placed in a location to be hidden in the closed state.

8. The mobile device according to claim 7, wherein
the first object is associated with a function or information which is configured to be operated by using the first operating unit and without using the second operating unit, and
the second object is associated with a function or information which is configured to be operated by using the second operating unit.

9. The mobile device according to claim 1, wherein
the housing includes a first housing, and a second housing disposed overlapping the first housing, and the closed state and the opened state are switched by relatively moving the first housing and the second housing while respective opposed faces of the first housing and the second housing are maintained in parallel to each other.

10. The mobile device according to claim 1, further comprising a call key; a direction key; a number key at least placed at a location to be hidden when the housing is in the closed state; and a communication unit, wherein
in a state where the standby screen and the second object are displayed on the display unit,
when the direction key is operated, the second object is selected, and
when the number key is operated, movement to a screen on which a number corresponding to the operated key is displayed on the display unit is made, and then, when the call key is operated, the communication unit performs a calling process by using an input number sequence as a telephone number.

11. A mobile device comprising:
a housing configured to be switched to an opened state or a closed state;
a display unit for displaying a standby screen, the display unit being exposed in any state of the opened state and the closed state of the housing;
a storage unit for storing an object associated with an icon and a text and to be displayed on the standby screen; and
a control unit for causing the object to be displayed by using an icon that does not accompany the text in a first state where the standby screen is displayed in the closed state, and the object that accompanies the text to be displayed in a second state where the standby screen is displayed in the opened state.

12. The mobile device according to claim 11, wherein
the housing includes a first housing, and a second housing disposed overlapping the first housing, and
the closed state and the opened state are switched by relatively moving the first housing and the second housing while respective opposed faces of the first housing and the second housing are maintained in parallel to each other.

13. A display control method in a mobile device including a housing configured to be switched to an opened state or a closed state, and a display unit being exposed in any of states where the housing is switched, the display control method comprising:
displaying a standby screen on the display unit;
displaying a first object to be displayed on the standby screen in a first state where the standby screen is displayed in the closed state; and
displaying a second object differing from the first object in a second state where the standby screen is displayed in the opened state.

14. A display control method in a mobile device including a housing configured to be switched to an opened state or a closed state, a display unit being exposed in any of states where the housing is switched, and a storage unit for storing an object associated with an icon and a text, the display control method comprising:
displaying a standby screen on the display unit;
displaying the object by using the icon that does not accompany the text in a first state where the standby screen is displayed in the closed state; and
displaying the object that accompanies the text in a second state where the standby screen is displayed in an opened state.
